(19) United States
(12) Patent Application Publication
(10) Pub. No.: US 2025/0149201 A1
(43) Pub. Date: May 8, 2025

(54) CONFINEMENT APPARATUS LOADING ASSEMBLY USING SELECTED LASER TONES

(71) Applicant: Quantinuum LLC, Broomfield, CO (US)

(72) Inventors: Robert Tucker SPRENKLE, Firestone, CO (US); Brian Joseph DESALVO, Denver, CO (US); John Patrick BARTOLOTTA, Lafayette, CO (US); Christopher Newman GILBRETH, Erie, CO (US)

(21) Appl. No.: 18/907,037

(22) Filed: Oct. 4, 2024

Related U.S. Application Data
(60) Provisional application No. 63/596,698, filed on Nov. 7, 2023.

(51) Int. Cl. G21K 1/00

(52) U.S. Cl. CPC G21K 1/003

(57) ABSTRACT

A loading assembly for providing atomic objects to a confinement apparatus is provided. The loading assembly includes an oven configured to generate an atomic flux of an atomic species/isotope having a non-zero nuclear spin. The loading assembly includes mirror and magnet arrays configured to, when optical beams are provided to the arrays, generate a two-dimensional magneto-optical trap (2D MOT) with a simplified repumping scheme. The 2D MOT is configured to generate a substantially collimated atomic beam from the oven generated atomic flux.

### CROSS-REFERENCE TO RELATED APPLICATION(S)

This application claims priority to U.S. Application No. 63/596,698, filed Nov. 7, 2023, the contents of which are incorporated herein by reference in its entirety.

### TECHNICAL FIELD

Various embodiments relate to apparatuses, systems, and methods relating to loading an atomic object confinement apparatus, such as an ion trap, for example, with atomic objects, such as ions, for example. Various embodiments relate to reducing a number of laser tones required for loading atomic objects having a non-zero nuclear spin into an atomic object confinement apparatus using a two-dimensional (2D) magneto-optical trap (MOT).

### BACKGROUND

Conventional atomic sources for loading ion traps provide a cloud of atoms, some of which are ionized and captured by the ion trap. However, a significant number of the atoms are not trapped and become background gas within the vacuum chamber that the ion trap is disposed within. Thus, conventional atomic sources load relatively slowly and compromise the performance of the vacuum within the vacuum chamber. Through applied effort, ingenuity, and innovation many deficiencies of prior ion trap loading techniques have been solved by developing solutions that are structured in accordance with the embodiments of the present invention, many examples of which are described in detail herein.

### BRIEF SUMMARY OF EXAMPLE EMBODIMENTS

Example embodiments provide methods, systems, apparatuses, computer program products and/or the like for loading atomic objects into an atomic object confinement apparatus by using a 2D MOT to convert a flux of atomic objects into an atomic beam. In various embodiments, the 2D MOT uses a reduced number of laser tones for addressing an atomic object having a non-zero nuclear spin.

According to an aspect of the present disclosure, a method for selecting repump laser tones for use in a two-dimensional (2D) magneto-optical trap (MOT) is provided. In an example embodiment, the 2D MOT is configured to deflect atomic objects of a first atomic object species/isotope via photon scattering using a deflection manipulation signal corresponding to a transition between a first state and a second state of the first atomic object species/isotope. In an example embodiment, the method includes obtaining/identifying a range of target object velocities; based at least in part on the range of target object velocities, determining an amount of time that an object is present within the 2D MOT; obtaining/selecting a threshold decay state probability; based at least in part on the amount of time that an object is present within the 2D MOT and the threshold decay state probability, determining a threshold branching ratio; and identifying one or more transitions between second state and a respective decay state of the first atomic object species/isotope that are characterized by respective branching ratios that are greater than or equal to the threshold branching ratio.

In an example embodiment, the method further includes determining laser tones corresponding to the one or more transitions.

In an example embodiment, the method further includes causing generation of a 2D MOT comprising the determined laser tones.

In an example embodiment, the 2D MOT is configured to cause an atomic beam generated from one or more atomic fluxes provided by one or more oven nozzles to be provided to a loading region of a confinement apparatus.

In an example embodiment, the range of target object velocities is determined based on a threshold kinetic energy of an atomic object provided to the loading region of the confinement apparatus that the confinement apparatus is capable of trapping.

In an example embodiment, the atomic beam comprises atomic objects of the first atomic object species/isotope and atomic objects of a second atomic object species/isotope.

In an example embodiment, the first atomic object species/isotope has a non-zero nuclear spin.

In an example embodiment, the range of target object velocities is velocities greater than 0 m/s and no more than 90 m/s.

In an example embodiment, the threshold branching ratio is 1:10,000.

According to another aspect, a loading assembly for providing atomic objects to a confinement apparatus is provided. In an example embodiment, the loading assembly includes one or more ovens. Each oven of the one or more ovens (a) comprises a respective oven nozzle and (b) is configured to generate a respective atomic flux of a respective atomic species via the respective oven nozzle. The loading assembly further includes a mirror array and a magnet array configured to, when optical beams are provided to the mirror array, generate a two-dimensional magneto-optical trap (2D MOT). The 2D MOT is configured to generate a substantially collimated atomic beam from the respective atomic fluxes generated by the one or more ovens by deflecting atomic objects of a first atomic object species/isotope via photon scattering using a deflection manipulation signal corresponding to a transition between a first state and a second state of the first atomic object species/isotope. The loading assembly further includes a differential pumping tube defining a beam path, wherein the differential pumping tube is configured to provide the substantially collimated atomic beam via the beam path. The optical beams of the 2D MOT comprise one or more repump manipulation signals configured to address a first respective atomic species/isotope. The one or more repump manipulation signals consist of respective laser beams characterized by respective frequencies that correspond to respective transitions associated with respective branching ratios that are greater than or equal to a threshold branching ratio.

In an example embodiment, the threshold branching ratio is determined by obtaining a range of target object velocities; based at least in part on the range of target object velocities, determine an amount of time that an object is present within the 2D MOT; obtaining a threshold decay state probability; and based at least in part on the amount of time that an object is present within the 2D MOT and the threshold decay state probability, determining the threshold branching ratio.

In an example embodiment, the 2D MOT is configured to cause the atomic beam to be provided to a loading region of a confinement apparatus.

In an example embodiment, the range of target object velocities is determined based on a threshold kinetic energy of an atomic object provided to the loading region of the confinement apparatus that the confinement apparatus is capable of trapping.

In an example embodiment, the atomic beam comprises atomic objects of the first atomic object species/isotope and atomic objects of a second atomic object species/isotope.

In an example embodiment, the range of target object velocities is velocities greater than 0 m/s and no more than 90 m/s.

In an example embodiment, the first respective atomic species/isotope has a non-zero nuclear spin.

In an example embodiment, the threshold branching ratio is 1:10,000.

In an example embodiment, the respective oven nozzle of each of the one or more ovens is misaligned with the beam path and the 2D MOT is configured to provide the substantially collimated atomic beam in alignment with the beam path.

In an example embodiment, the loading assembly is part of a quantum charge-coupled device (QCCD)-based quantum computer.

According to another aspect, an apparatus configured for selecting repump laser tones for use in a two-dimensional (2D) magneto-optical trap (MOT) is provided. In an example embodiment, the 2D MOT is configured to deflect atomic objects of a first atomic object species/isotope via photon scattering using a deflection manipulation signal corresponding to a transition between a first state and a second state of the first atomic object species/isotope. In an example embodiment, the apparatus comprises a processing device and at least one memory storing computer executable instructions, the at least one memory and the computer executable instructions are configured to, when executed by the processing device, cause the apparatus to perform at least obtaining/identifying a range of target object velocities; based at least in part on the range of target object velocities, determining an amount of time that an object is present within the 2D MOT; obtaining/selecting a threshold decay state probability; based at least in part on the amount of time that an object is present within the 2D MOT and the threshold decay state probability, determining a threshold branching ratio; and identifying one or more transitions between second state and a respective decay state of the first atomic object species/isotope that are characterized by respective branching ratios that are greater than or equal to the threshold branching ratio.

In an example embodiment, the at least one memory and the computer executable instructions are further configured to, when executed by the processing device, cause the apparatus to perform at least includes determining laser tones corresponding to the one or more transitions.

In an example embodiment, the at least one memory and the computer executable instructions are further configured to, when executed by the processing device, cause the apparatus to perform at least includes causing generation of a 2D MOT comprising the determined laser tones.

In an example embodiment, the 2D MOT is configured to cause an atomic beam generated from one or more atomic fluxes provided by one or more oven nozzles to be provided to a loading region of a confinement apparatus.

In an example embodiment, the range of target object velocities is determined based on a threshold kinetic energy of an atomic object provided to the loading region of the confinement apparatus that the confinement apparatus is capable of trapping.

In an example embodiment, the atomic beam comprises atomic objects of the first atomic object species/isotope and atomic objects of a second atomic object species/isotope.

In an example embodiment, the first atomic object species/isotope has a non-zero nuclear spin.

In an example embodiment, the range of target object velocities is velocities greater than 0 m/s and no more than 90 m/s.

In an example embodiment, the threshold branching ratio is 1:10,000.

According to another aspect, a computer program product is provided. The computer program product is configured to cause an apparatus to select repump laser tones for use in a two-dimensional (2D) magneto-optical trap (MOT). In an example embodiment, the 2D MOT is configured to deflect atomic objects of a first atomic object species/isotope via photon scattering using a deflection manipulation signal corresponding to a transition between a first state and a second state of the first atomic object species/isotope. In an example embodiment, the computer program product comprises at least one non-tangible memory storing computer executable instructions. The computer executable instructions are configured to, when executed by a processing device of the apparatus, cause the apparatus to perform at least obtaining/identifying a range of target object velocities; based at least in part on the range of target object velocities, determining an amount of time that an object is present within the 2D MOT; obtaining/selecting a threshold decay state probability; based at least in part on the amount of time that an object is present within the 2D MOT and the threshold decay state probability, determining a threshold branching ratio; and identifying one or more transitions between second state and a respective decay state of the first atomic object species/isotope that are characterized by respective branching ratios that are greater than or equal to the threshold branching ratio.

In an example embodiment, the computer executable instructions are further configured to, when executed by a processing device of the apparatus, cause the apparatus to perform includes determining laser tones corresponding to the one or more transitions.

In an example embodiment, the computer executable instructions are further configured to, when executed by a processing device of the apparatus, cause the apparatus to perform at least includes causing generation of a 2D MOT comprising the determined laser tones.

In an example embodiment, the 2D MOT is configured to cause an atomic beam generated from one or more atomic fluxes provided by one or more oven nozzles to be provided to a loading region of a confinement apparatus.

In an example embodiment, the range of target object velocities is determined based on a threshold kinetic energy of an atomic object provided to the loading region of the confinement apparatus that the confinement apparatus is capable of trapping.

In an example embodiment, the atomic beam comprises atomic objects of the first atomic object species/isotope and atomic objects of a second atomic object species/isotope.

In an example embodiment, the first atomic object species/isotope has a non-zero nuclear spin.

In an example embodiment, the range of target object velocities is velocities greater than 0 m/s and no more than 90 m/s.

In an example embodiment, the threshold branching ratio is 1:10,000.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram illustrating an example quantum computing system comprising an atomic object confinement apparatus, according to an example embodiment.

FIG. 2 is a side view of an example loading assembly configured to provide a multiple species atomic beam to a loading position of an atomic object confinement apparatus, according to an example embodiment.

FIG. 3 is a cross-sectional view of the example loading assembly shown in FIG. 2 along the A-A line, according to an example embodiment.

FIG. 4 provides a flowchart illustrating processes and/or procedures performed, for example, by a computing entity of FIG. 7, for providing a 2D MOT with a reduced number of repumping tones, according to an example embodiment.

FIG. 5 provides a partial energy diagram of an example atomic object, according to an example embodiment.

FIG. 6 provides a schematic diagram of an example controller of a quantum computer configured to perform one or more deterministic reshaping and/or reordering functions, according to various embodiments.

FIG. 7 provides a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

Example embodiments provide methods, systems, apparatuses, computer program products and/or the like for loading atomic objects into an atomic object confinement apparatus. In various embodiments, two or more species of atomic objects are loaded into the atomic object confinement apparatus. In various embodiments, a loading assembly comprises an oven configured to provide a flux of atomic objects. In various embodiments, the loading assembly comprises multiple ovens, with each oven configured to provide a flux of atomic objects of a respective species. In various embodiments, each of the ovens is misaligned from the atomic object confinement apparatus and/or a loading position of the atomic object confinement apparatus. In various embodiments, the loading assembly is configured to generate a substantially collimated atomic beam.

In various embodiments, the loading assembly is configured to generate first substantially collimated single species atomic beam (e.g., a qubit atomic object species beam) and a second single species atomic beam (e.g., a sympathetic cooling atomic object species beam) at different and/or alternating times. In various embodiments, the loading assembly is configured to generate a substantially collimated multiple species atomic beam that is directed toward and/or aligned with the atomic object confinement apparatus and/or the loading position of the atomic object confinement apparatus.

In various embodiments, the atomic objects are atoms, ions, molecules, and/or the like. In various embodiments, the atomic object confinement apparatus is configured to confine atomic objects. For example, in an example embodiment, the atomic object confinement apparatus is a surface and/or Paul ion trap and the atomic objects are atoms that are ionized at the loading position of the atomic object confinement apparatus.

In various embodiments, the loading assembly comprises a 2D magneto-optical trap (MOT). In various embodiments, atomic fluxes generated by the one or more ovens of the loading assembly exit the respective ovens and flow into the 2D MOT. As noted above, the ovens are offset from the atomic object confinement apparatus and/or the loading position of the atomic object confinement apparatus. The 2D MOT collimates the incoming atomic fluxes and redirects the atomic fluxes such that a collimated, multiple species atomic beam is provided by the loading apparatus to the atomic object confinement apparatus and/or a loading position of the atomic object confinement apparatus.

For a respective species of atomic object, the 2D MOT collimates a flux of atomic objects by scattering photons off of the respective atomic objects to cause any components of atomic object velocity that are transverse to and/or radial with respect to a MOT axis defined by the 2D MOT to be dampened and/or depleted. For example, in various embodiments the flux of atomic objects is provided to the 2D MOT at a non-zero angle to the MOT axis. The 2D MOT is configured to deflect the atomic objects by scattering photons off of the respective atomic objects to cause any components of atomic object velocity that are transverse to and/or radial with respect to a MOT axis defined by the 2D MOT to be dampened and/or depleted.

In an example embodiment the scattering of a photon off of a respective atomic object is performed via a selected transition of the atomic object. In various embodiments, the selected transition is a transition from a first state of the atomic object to a second state of the atomic object. In an example embodiment, where the atomic objects are ¹³⁷Ba atoms, the selected transition is an ¹S₀ to ¹P₁ transition of the atomic object. However, it should be understood that the selected transition of the atomic object may vary between different species and/or isotopes of atomic objects. Additionally, in some example embodiments, the repump lasers also scatter photons off of a respective atomic object such that the number of scatters is significant enough to contribute to cooling the atomic object. For example, the repump lasers may be used to perform cooling of atomic objects.

For example, a deflection manipulation signal (e.g., a laser beam) of the 2D MOT that is characterized by a frequency that corresponds to the selected transition (e.g., a ¹S₀ to ¹P₁ transition in an example embodiment) of the atomic object interacts with the atomic object. The atomic object undergoes the selected transition and undergoes a change in the atomic object's velocity as a result of the deflection manipulation signal interacting with the atomic object. In an example embodiment, the frequency of the deflection manipulation signal is red detuned from the selected transition so as to provide additional cooling of the atomic objects via interaction with the deflection manipulation signal.

In various embodiments, hundreds or thousands of individual deflection events are used to reduce the temperature of the atomic object transverse to the MOT axis. After undergoing the selected transition (e.g., ¹S₀ to ¹P₁ transition in an example embodiment where the atomic objects are ¹³⁷Ba atoms), the atomic object decays from the resultant second state (e.g., the ¹P₁ state in the example embodiment where the atomic objects are ¹³⁷Ba atoms) to a lower energy state. In instances where the atomic object decays back to the first state (e.g., the ¹S₀ state in the example embodiment where the atomic objects are ¹³⁷Ba atoms), the atomic object may be deflected again. However, in instances where the atomic object decays into a state other than the first state, the atomic object is repumped using a repump manipulation signal to provide a path for the atomic object back to the first state (e.g., via the second state or another excited state).

For species/isotopes of atomic objects having zero nuclear spin, there are a small number of decay states into which the atomic object may decay from the second state. However, for species/isotopes of atomic objects having non-zero nuclear spin, there are a significant number of decay states into which the atomic object may decay from the second state. For example, in the example of ¹³⁷Ba, there are eleven states other than the first state (e.g., the ¹S₀ state) that the atomic object may decay to from the second state (e.g., the ¹P₁ state). Therefore, according to conventional practice, a 2D MOT for forming an atomic beam of ¹³⁷Ba from an oven provided atomic flux of ¹³⁷Ba would include a deflection manipulation signal characterized by a frequency corresponding to the selected transition (e.g., the S₀ to P₁ transition) and eleven repump manipulation signals, each characterized by a respective frequency corresponding to a transition from a respective decay state to the second state (e.g., the ¹P₁ state) and/or another excited state. In other words, a 2D MOT for forming an atomic beam of ¹³⁷Ba from an oven provided atomic flux of ¹³⁷Ba would require twelve different laser tones, according to conventional practice. As understood by one of ordinary skill in the art a laser tone is at least a portion of a laser beam characterized by a respective tone, frequency, or wavelength.

Given the technical complexity of generating a 2D MOT including twelve different laser tones, for example, there are technical problems for generating a 2D MOT configure to collimate atomic objects having non-zero nuclear spin.

Embodiment of the present disclosure provide technical solutions to these technical problems. In particular, various embodiments provide a method and/or corresponding apparatus for reducing the number of possible repump manipulation signals used in a 2D MOT configured for collimating atomic objects having non-zero nuclear spin. In various embodiments, a system configured for generating a 2D MOT with a reduced number of repump manipulation signals is provided.

For example, the decay states which are particularly relevant given the application and the geometry of the 2D MOT are identified. For example, the application may define a range of target object velocities. As used herein, the target object velocity is a velocity component aligned with the MOT axis. For example, the 2D MOT may be configured to provide a collimated atomic beam including atomic objects having respective axial velocities (velocity components aligned with and/or parallel to the MOT axis) within the range of target object velocities. The geometry of the 2D MOT and the range of target object velocities provides an indication of the amount of time an atomic object will spend in the 2D MOT. Based on the application, a threshold decay state probability may be set or selected. A decay state probability is the likelihood that an atomic object will decay from the second state (e.g., the ¹P₁ state in the example where the atomic objects are ¹³⁷Ba atoms) into a respective decay state. Based on the amount of time the atomic object will spend in the 2D MOT and the threshold decay state probability, a threshold branching ratio is determined.

Decay states having a branching ratio greater than the threshold branching ratio with respect to the second state (e.g., the ¹P₁) state are identified. Laser tones and/or frequencies corresponding to respective transitions between the decay states having respective branching ratios greater than the threshold branching ratio with respect to the second state are determined, in various embodiments. In an example embodiment, a 2D MOT is generated and/or caused to be generated that includes repump manipulation signals that are characterized by frequencies corresponding to the respective transitions between the decay states having respective branching ratios greater than the threshold branching ratio to the second state (e.g., the ¹P₁ state in an example of ¹³⁷Ba atoms) and/or another excited state of the atomic objects. The 2D MOT does not include repump manipulation signals that correspond to the respective transitions between the decay states having respective branching ratios less than the threshold branching ratio to the second state or other excited state.

Thus, various embodiments provide for 2D MOTs that are configured to collimate atomic objects having non-zero nuclear spin but with a significantly reduced technical implementation complexity. For example, in various embodiments, the number of repump manipulation signals of the 2D MOT configured to address an atomic object having a non-zero nuclear spin is similar to the number of repump manipulation signals of a 2D MOT configured to address an atomic object having a zero nuclear spin. For example, in an example embodiment, a 2D MOT configured to collimate ¹³⁷Ba into an atomic beam includes three repump manipulation signals (e.g., 3 laser tones configured for repumping the ¹³⁷Ba) compared to the eleven repump manipulation signals required by conventional practice. Therefore, embodiments provide improvements to the technical fields of 2D MOTs and loading atomic objects into an atomic object confinement apparatus.

### Exemplary Quantum Computing System Comprising a Loading Assembly

In various embodiments, a loading assembly that includes a 2D MOT with a reduced number of repumping manipulation signals is configured to provide an atomic beam to a loading position of an atomic object confinement apparatus. The atomic object confinement apparatus may be part of various types of atomic systems. In various embodiments, the atomic object confinement apparatus (and possibly the loading assembly) is part of a quantum charge-coupled device (QCCD)-based quantum computing system 100.

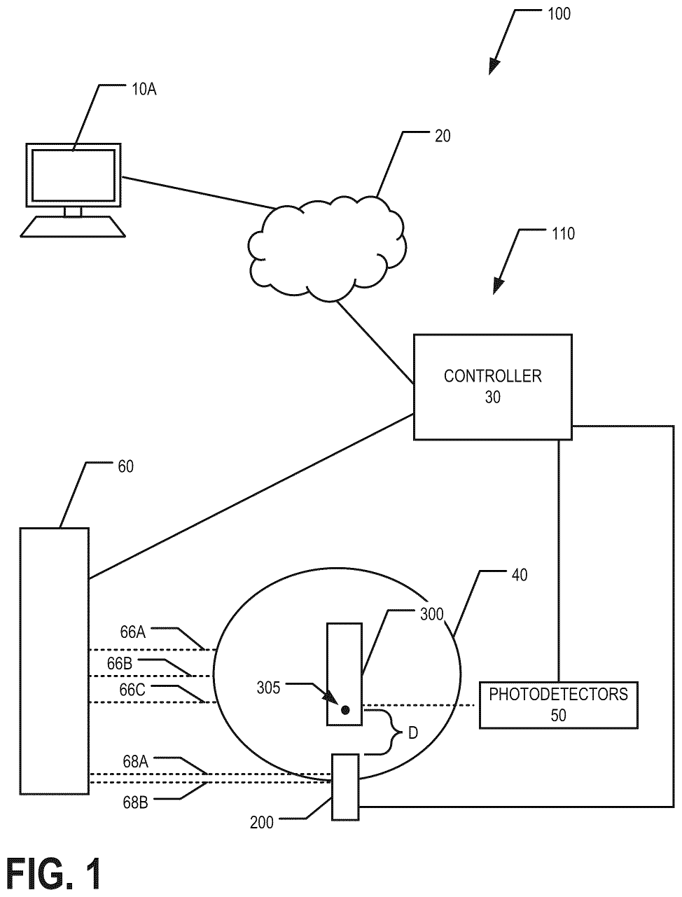

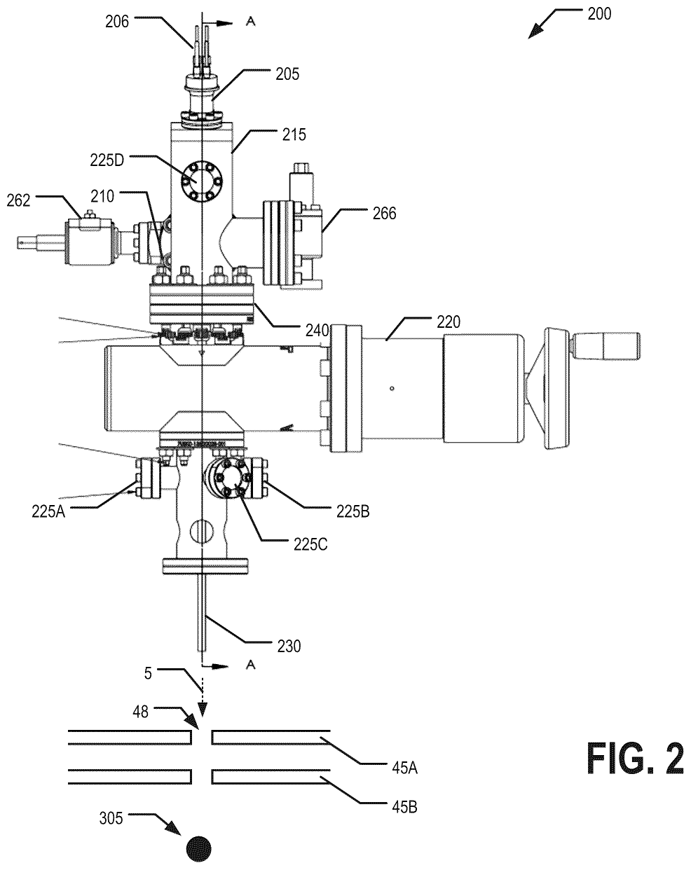

FIG. 1 provides a schematic diagram of an example QCCD-based quantum computing system 100 comprising an atomic object confinement apparatus 300 (e.g., an ion trap and/or the like) and a loading assembly 200, in accordance with an example embodiment. As shown in FIG. 2, the loading assembly 200 is configured to provide a substantially collimated atomic beam 5 to the atomic object confinement apparatus 300. For example, the loading assembly 200 is configured to provide a substantially collimated atomic beam 5 toward a loading position 305 of the atomic object confinement apparatus 300, in various embodiments. In various embodiments, the quantum computing system 100 comprises an ionizing laser and corresponding optical elements configured to provide an ionizing laser beam that ionizes atomic objects of the substantially collimated atomic beam 5. The ionized atomic objects are then trapped and/or confined by a trapping potential generated by electrodes of the atomic object confinement apparatus 300. An example linear atomic object confinement apparatus is described by U.S. application Ser. No. 16/717,602, filed Dec. 17, 2019, though various other linear atomic object confinement apparatuses may be used in various embodiments. An example two-dimensional atomic object confinement apparatus is described by U.S. Application No. 63/199,279, filed Dec. 17, 2020, though various other two-dimensional atomic object confinement apparatuses may be used in various embodiments.

In various embodiments, the loading assembly 200 and the atomic object confinement apparatus 300 (and/or a loading position 305 of the atomic object confinement apparatus) are separated from one another by a distance D. In various embodiments, the distance D is at least 0.25 meters (e.g., in a range of 0.25 to 1.0 meters). In an example embodiment, the distance D is substantially equal to 0.4 meters.

In various embodiments, one or more radiation and/or thermal shields 45 (e.g., 45A, 45B) are disposed between the loading assembly 200 and the atomic object confinement apparatus 300. In various embodiments, each of the one or more radiation and/or thermal shields 45 comprises an opening 48 therethrough. The opening(s) 48 are aligned with the differential pumping tube 230 and/or the loading position 305 of the atomic object confinement apparatus 300 such that the substantially collimated atomic beam 5 can travel from the differential pumping tube 230 through the openings 48 of the radiation and/or thermal shields 45 to the loading position 305 of the atomic object confinement apparatus 300.

In various embodiments, the quantum computing system 100 comprises a computing entity 10A and a quantum computer 110. In various embodiments, the quantum computer 110 comprises a controller 30, a cryostat and/or vacuum chamber 40 enclosing the atomic object confinement apparatus 300 (e.g., an ion trap) and at least a portion of the loading assembly 200, and one or more manipulation sources 60. For example, the cryostat and/or vacuum chamber 40 may be a pumping and/or temperature-controlled chamber. In an example embodiment, the manipulation signals generated by the manipulation sources 60 are provided to the interior of the cryostat and/or vacuum chamber 40 (where the atomic object confinement apparatus 300 is located) via corresponding optical paths 66 (e.g., 66A, 66B, 66C). In an example embodiment, the one or more manipulation sources 60 may comprise one or more lasers (e.g., optical lasers, microwave sources, and/or the like). In various embodiments, each manipulation source 60 is configured to generate a manipulation signal having a respective characteristic wavelength in the microwave, infrared, visible, or ultraviolet portion of the electromagnetic spectrum.

In various embodiments, the manipulation sources 60 include one or more deflection manipulation sources configured to generate and provide one or more deflection manipulation signals and one or more repump manipulation sources configured to generate and provide one or more repump manipulation signals. For example, the deflection manipulation signals and/or repump manipulation signals may be provided to the loading assembly 200 via respective beam path systems 68 (e.g., 68A, 68B).

In various embodiments, the one or more manipulation sources 60 are configured to manipulate and/or cause a controlled quantum state evolution of one or more atomic objects within the atomic object confinement apparatus 300, ionize atomic objects of the substantially collimated atomic beam 5, generate and provide a laser beam for generating a 2D MOT, cooling one or more species of atomic objects, and/or the like. For example, in various embodiments, the one or more manipulation sources 60 comprise one or more lasers and, in some embodiments, corresponding optical elements defining an optical path for delivering one or more manipulation signals to an appropriate position within the cryostat and/or vacuum chamber 40 and/or to a respective optical coupler 210 of the loading assembly. For example, the manipulation sources 60 may be configured to generate one or more beams that may be used to deflect an atomic object via the 2D MOT, repump an atomic object within the 2D MOT, ionize an atomic object, initialize an atomic object into a state of a qubit space such that the atomic object may be used as a qubit of the confined atomic object quantum computer, perform one or more gates on one or more qubits of the confined atomic object quantum computer, read and/or determine a state of one or more qubits of the confined atomic object quantum computer, ionize an atomic object, and/or the like. In an example embodiment, the manipulation sources 60 comprise one or more lasers configured to generate optical beams used to form the 2D MOT.

In various embodiments, the 2D MOT comprises optical beams generated by manipulation sources 60. In various embodiments, the optical beams comprise deflection manipulation signals and one or more repump manipulation signals for each species of atomic object to be provided to the loading position 305 of the atomic object confinement apparatus 300. In various embodiments, deflection manipulation signal(s) and the one or more repump manipulation signals are coupled together to produce the MOT.

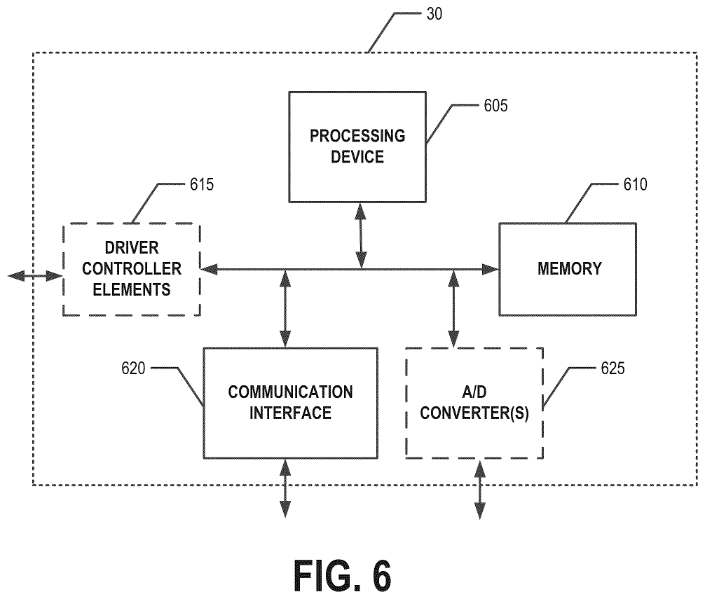

In various embodiments, the quantum computer 110 comprises an optics collection system configured to collect and/or detect photons generated by qubits (e.g., during reading procedures). The optics collection system may comprise one or more optical elements (e.g., lenses, mirrors, waveguides, fiber optics cables, and/or the like) and one or more photodetectors 50. In various embodiments, the photodetectors may be photodiodes, photomultipliers, charge-coupled device (CCD) sensors, complementary metal oxide semiconductor (CMOS) sensors, Micro-Electro-Mechanical Systems (MEMS) sensors, and/or other photodetectors that are sensitive to light at an expected fluorescence wavelength of the qubits of the quantum computer. In various embodiments, the detectors may be in electronic communication with the controller 30 via one or more A/D converters 625 (see FIG. 6) and/or the like. For example, an atomic object being read and/or having its quantum state determined may emit an emitted signal, at least a portion of which is incident on a collection array of meta material structures formed and/or disposed on the surface of the atomic object confinement apparatus 300. The emitted signal being incident on the collection array of meta material structures induces the meta material structures to emit a detected signal directed toward and/or focused on collection optics of the atomic object confinement apparatus. The collection optics are configured to provide the collection signal to a photodetector.

In various embodiments, the quantum computer 110 comprises one or more voltage sources. For example, the voltage sources may comprise a plurality of voltage drivers and/or voltage sources and/or at least one RF driver and/or voltage source. The voltage sources may be electrically coupled to the corresponding potential generating elements (e.g., electrodes) of the confinement apparatus 300, in an example embodiment. In various embodiments, application of voltages provided by the voltage sources to the electrodes of the confinement apparatus 300 generates a trapping and/or confining potential configured to confine ionized atomic objects by the atomic object confinement apparatus 300.

In various embodiments, a classical (e.g., semiconductor-based) computing entity 10A is configured to allow a user to provide input to the quantum computer 110 (e.g., via a user interface of the computing entity 10A) and receive, view, and/or the like output from the quantum computer 110. The computing entity 10A may be in communication with the controller 30 of the quantum computer 110 via one or more wired or wireless networks 20 and/or via direct wired and/or wireless communications. In an example embodiment, the computing entity 10A may translate, configure, format, and/or the like information/data, quantum computing algorithms and/or circuits, and/or the like into a computing language, executable instructions, command sets, and/or the like that the controller 30 can understand and/or implement.

In various embodiments, the controller 30 is configured to control the voltage sources, cryostat system and/or vacuum system controlling the temperature and pumping within the cryostat and/or vacuum chamber 40, manipulation sources 60, and/or other systems controlling various environmental conditions (e.g., temperature, pumping, and/or the like) within the cryostat and/or vacuum chamber 40 and/or configured to manipulate and/or cause a controlled evolution of quantum states of one or more atomic objects within the confinement apparatus. For example, the controller 30 may cause a controlled evolution of quantum states of one or more atomic objects within the confinement apparatus to execute a quantum circuit and/or algorithm. For example, the controller 30 may cause a reading procedure comprising coherent shelving to be performed, possibly as part of executing a quantum circuit and/or algorithm. In various embodiments, the atomic objects confined within the confinement apparatus are used as qubits of the quantum computer 110.

### Example Loading Assembly

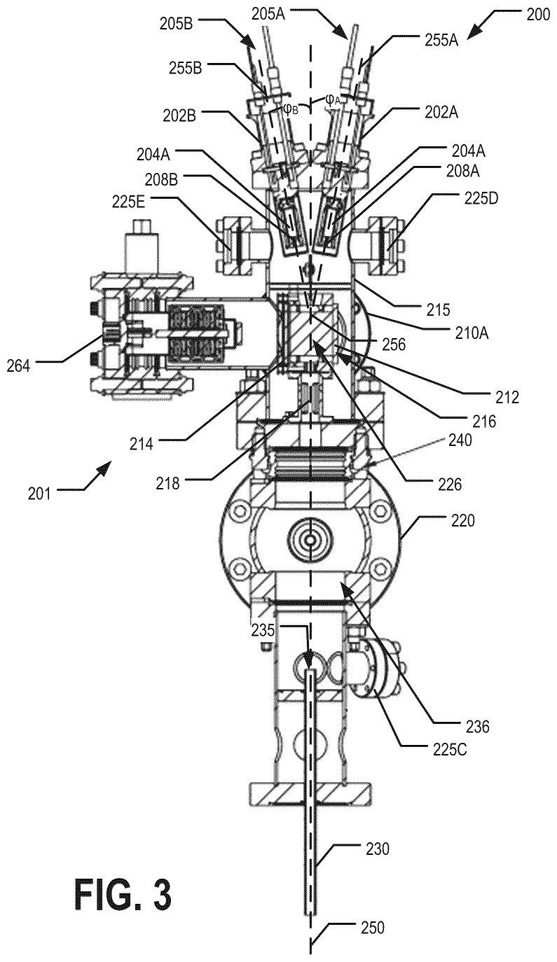

FIG. 2 illustrates a sideview of an example loading assembly 200 and FIG. 3 illustrates a cross-sectional view of the loading assembly 200. In various embodiments, the loading assembly 200 comprises one or more ovens 205 (e.g., 205A, 205B). Each oven 205 is configured to provide an atomic flux of a particular atomic object species (e.g., a qubit atomic object species and/or a sympathetic cooling atomic object species).

The loading assembly 200 further comprises a MOT chamber 216 configured for formation of a 2D MOT therein. In various embodiments, the 2D MOT formed within the MOT chamber 216 is configured to deflect individual atomic objects from the atomic flux to form a collimated atomic beam. The MOT chamber 216 and/or the 2D MOT defines a MOT axis 256. In various embodiments, the collimated atomic beam exits the MOT chamber 216 along the MOT axis 256.

In various embodiments, the atomic flux and/or collimated atomic beam includes one or more species/isotopes of atomic objects. In an example embodiment, the atomic flux includes more than one species/isotope of atomic objects and the 2D MOT is configured to collimate a single species/isotope of atomic objects into the collimated atomic beam. In an example embodiment, the atomic flux includes more than one species/isotope of atomic objects and the 2D MOT is configured to collimate more than one species/isotope of atomic objects into the collimated atomic beam.

In various embodiments, the loading assembly comprises a differential pumping tube 230. In various embodiments, the differential pumping tube 230 is aligned with the MOT axis 256. For example, the differential pumping tube 230 defines, at least in part, a beam path for the collimated atomic beam between the MOT chamber 216 and the loading position 305 of the atomic object confinement apparatus 300.

In various embodiments, the loading assembly 200 is located and/or disposed a distance away from the atomic object confinement apparatus 300. For example, the loading assembly is located and/or disposed more than 0.25 meters (e.g., approximately 0.4 meters) from the atomic object confinement apparatus, in an example embodiment. Thus, the loading assembly 200 does not introduce a significant amount of thermal energy in the vicinity of the atomic object confinement apparatus 300. In various embodiments, one or more thermal and/or radiation shields are disposed between the loading assembly 200 and the atomic object confinement apparatus 300.

In various embodiments, an ionization manipulation signal (e.g., a laser beam) ionizes atomic objects in the atomic beam as the atomic beam approaches the atomic object confinement apparatus 300 and/or the loading position 305 of the atomic object confinement apparatus 300. The ionized atomic objects, which comprise one or more species/isotopes of ions, are then captured by the trapping potential of the atomic object confinement apparatus 300.

In various embodiments, the atomic object confinement apparatus 300 is an ion trap, such as a surface Paul trap, for example. In various embodiments, the atomic object confinement apparatus 300 is configured to be a quantum processor of a quantum computer for performing and/or executing quantum circuits and/or algorithms. In an example embodiment, the atomic beam provided to the confinement apparatus 300 and/or the loading position 305 of the confinement apparatus 300 includes a species/isotope of atomic objects used as a qubit of the quantum computer. In an example embodiment, the atomic beam provided to the confinement apparatus 300 and/or a loading position 305 of the confinement apparatus 300 includes a species/isotope of atomic objects used as a sympathetic cooling ion of the quantum computer.

In various embodiments, the atomic object confinement apparatus 300 comprises a plurality of electrodes that are configured to generate a confining potential. For example, the controller 30 of the quantum computing system 100 may control a plurality of voltage sources to provide electrical signals to the electrodes of the atomic object confinement apparatus 300 such that the electrodes generate a confining potential. The confining potential is configured to confine a plurality of atomic objects within a confinement volume defined by the atomic object confinement apparatus 300. For example, in an example embodiment, the atomic object confinement apparatus is a surface ion trap, and the confinement volume is a volume located proximate the surface of the surface ion trap. For example, the electrodes and/or confining potential are configured to define a plurality of atomic object positions within the confinement volume.

In various embodiments, the atomic object confinement apparatus 300 is loaded by providing a substantially collimated atomic beam 5 toward a loading position 305 of the atomic object confinement apparatus 300 and then ionizing the atomic objects within the substantially collimated atomic beam via an ionizing beam (e.g., a laser beam configured to ionize the atomic objects) when the atomic objects are close enough to the atomic object confinement apparatus 300 to be trapped by the confining potential generated by the atomic object confinement apparatus.

As shown in FIGS. 2 and 3 in various embodiments, the loading assembly 200 comprises a housing 215. In various embodiments, the housing 215 comprises a coupler 240 configured to couple the housing 215 to a flange, for example, of a cryostat and/or vacuum chamber 40 containing the atomic object confinement apparatus 300. In various embodiments, the housing 215 provides a structure (e.g., one or more optical coupler 210 to which optical elements (e.g., optical fibers) of beam path systems 68 may be coupled to provide the optical beams (e.g., deflection manipulation signals, repump manipulation signals) to form the MOT.

In various embodiments, the housing 215 further provides a structure to which a mirror array 214 is coupled. In various embodiments, the mirror array comprise a plurality of mirrors configured to, when one or more deflection manipulation signals and repump manipulation signals are reflected therefrom, form the optical field of a 2D MOT. In various embodiments, the mirrors of the mirror array 214 are configured to reflect manipulation signals (e.g., optical beams) of different wavelengths. In various embodiments, the mirror array 214 comprises four or more mirrors (e.g., five mirrors) configured to cause one or more deflection manipulation signals and/or repump manipulation signals to cross the MOT axis 256 four times and from four different directions to form the 2D MOT. Moreover, the mirrors are configured to preserve the power and polarization of the one or more deflection manipulation signals and/or repump manipulation signals as the signals reflect off of the mirrors.

In various embodiments, the mirrors comprise a multilayer coating comprising multiple layers (e.g., more than two layers) of different kinds of glass such that the mirrors are able to reflect the one or more deflection manipulation signals and/or repump manipulation signals in along the prescribed path while maintaining and/or preserving the power and polarization of the manipulation signals (e.g., optical beam). For example, the mirrors absorb very little to none of the power of the one or more deflection manipulation signals and/or repump manipulation signals when the manipulation signals reflect off of the mirror due to the multilayer coating.

In various embodiments, the housing 215 provides a structure that is further configured to have one or more components of a vacuum system coupled thereto. For example, the housing 215 comprises a connector 262 configured for coupling an ion pump or other vacuum pump to the MOT chamber 216 and/or a non-evaporable getter 264 and/or couplings for attaching such to the housing 215. The ion pump and/or non-evaporable getter are part of a pump out apparatus and/or vacuum pump system configured to generate a vacuum within the loading assembly 200 (e.g., within MOT chamber 216 and/or dispensing chamber 236). For example, the pump out apparatus and/or vacuum pump system is configured to remove background gas and/or atomic gas that is not part of a substantially collimated atomic object beam from the interior of the loading assembly 200 (e.g., MOT chamber 216 and/or dispensing chamber 236). This reduces the amount of background gas present in the cryostat and/or vacuum chamber 40 that was contributed by the loading assembly 200. In an example embodiment, the housing 215 further comprises a valve 266 for use in connecting an external pump to the housing 215. For example, an external pump may be attached to the housing 215 during a bakeout procedure used to clean out the ovens 205 prior to operation of the loading assembly 200. In an example embodiment, the valve 266 is closed and an external pump is not secured thereto when the loading assembly 200 is operated to provide a substantially collimated atomic object beam.

In various embodiments, the housing 215 provides a structure within which a mirror array 214 and magnet array 212 are secured and/or mounted such that, when the optical beams are provided via one or more optical couplers 210, the electro-magnetic field within the MOT chamber 216 forms a 2D MOT. For example, the housing 215 may provide a frame to which the mirror array 214 and magnet array 212 are mounted.

In various embodiments, the mirror array 214 and/or magnet array 212, and/or a frame to which they are mounted, is mounted to and/or supported by support structure 218. For example, the support structure 218 may be secured at a first end to coupler 240 and extend from the coupler 240 into the MOT chamber 216. The mirror array 214 and/or magnet array 212, and/or a frame to which they are mounted, are mounted to a second end of the support structure 218 disposed within the MOT chamber 216. In an example embodiment, the support structure 218 comprises a through path aligned with the beam path 235, the beam path axis 250, and/or the MOT axis 256 such that the substantially collimated atomic object beam generated by the 2D MOT may pass through the support structure 218 to the dispensing chamber 236.

In various embodiments the mirror array 214 is configured and/or arranged such that the optical beams of the MOT (e.g., the one or more deflection manipulation signals and/or repump manipulation signals) enter the chamber through the optical coupler 210, pass through the MOT chamber 216 (e.g., cross the MOT axis 256 within MOT region 226) before encountering any mirrors of the mirror array 214. The MOT cooling beam then makes three 90 degree turns by reflecting off of three mirrors each at 45 degrees to the respective incident beam propagation direction. The optical beams of the MOT then cross their respective selves at the MOT location (e.g., within MOT region 226 along the MOT axis 256 that includes the original MOT axis 256 crossing), are retro reflected by a normal incidence mirror, and retrace their original beam path travelling in the opposite direction. The magnets of the magnet array 212 are positioned symmetrically around the MOT location and oriented to generate a magnetic field gradient with zero magnetic field within the MOT region 226.

In an example embodiment, the magnet array 212 is part of the frame configured to have the mirrors of the mirror array 214 mounted thereto. In various embodiments, the mirror array comprises a plurality of mirrors configured to generate an optical field of the 2D MOT within the MOT chamber 216. In various embodiments, the magnet array 212 is an array of one or more magnets configured to generate a magnetic field within the MOT chamber 216 so as to, with the optical field within the MOT chamber 216, generate a 2D MOT capable of generating a substantially collimated atomic object beam from the atomic fluxes provided to the MOT chamber 216 by the ovens 205.

In various embodiments, the 2D MOT defines a MOT axis 256. For example, the electro-magnetic field of the 2D MOT (e.g., within the MOT chamber 216) is configured to deflect the atomic objects within the MOT chamber 216 such that the respective velocities of the atomic objects align with the MOT axis 256. For example, the atomic objects traveling through the MOT chamber 216 may cluster about the MOT axis 256 and move in a direction along the MOT axis 256. In an example embodiment, the electro-magnetic field within the MOT chamber 216 is substantially the same in a first plane taken substantially perpendicular to the MOT axis 256 and a second plane taken at another point within the MOT chamber 216 and substantially perpendicular to the MOT axis 256. In various embodiments, the electro-magnetic potential of the 2D MOT (e.g., within the MOT chamber 216) has a stable minimum that extends along the MOT axis 256.

In various embodiments, the MOT axis 256 is aligned with a beam path axis 250 of the loading assembly 200. In various embodiments, the beam path axis 250 is defined by the beam path 235 defined by the differential pumping tube 230. For example, the MOT axis 256 is substantially parallel to and overlapping with the beam path axis 250.

In various embodiments, the loading assembly 200 comprises one or more ovens 205 (e.g., 205A, 205B). For example, the illustrated embodiment comprises two ovens—one for each species of atomic object to be loaded into the atomic object confinement apparatus 300. For example, in an example embodiment, the loading assembly 200 comprises a first oven and a second oven. The first oven is configured to generate a first atomic flux of a first atomic species and the second oven is configured to generate a second atomic flux of a second atomic species. The substantially collimated atomic beam 5 comprises atomic objects of both the first atomic species and the second atomic species. In the illustrated embodiment, the loading assembly 200 comprises a first species oven 205A and a second species oven 205B. In various embodiments, the one or more ovens 205A, 205B each define an oven axis 255A, 255B. In various embodiments, each oven axis 255A, 255B is substantially transverse to and/or not parallel to the MOT axis 256 and/or beam path axis 250. In other words, each of the one or more ovens 205 is misaligned with the beam path 235. In the illustrated embodiment, a first species oven 205A defines a first species oven axis 255A that forms an angle φ_{A} with the beam path axis 250 and a second species oven 205B defines a second species oven axis 255B that forms an angle φ_{B} with the beam path axis 250. In various embodiments, the angles φ_{A} and φ_{B} are the substantially equal. In an example embodiment, the angles φ_{A} and φ_{B} are different. In various embodiments, the angles φ_{A} and φ_{B} are each in a range of 5 to 45 degrees. In an example embodiment, the angles φ_{A} and φ_{B} are the substantially equal to and/or approximately 10 degrees.

In various embodiments, each oven 205A, 205B comprises heating control lines 206. The heating control lines pass through a respective one of feedthroughs 202A, 202B and are in electrical communication with a heating element of a corresponding heating chamber. For example, in various embodiments, the heating control lines 206 are configured for providing an electric current to a heating element within the heating chamber 204 (e.g., 204A, 204B) of the corresponding oven 205. In various embodiments, the controller 30 controls the electric current provided via the heating control lines 206. The heating element is configured to heat an atomic object comprising matter (e.g., a film, filament, solid, and/or the like) disposed within the heating chamber 204. For example, the first species oven 205A is configured to have an atomic object comprising matter comprising atomic objects of the first species disposed therein and the second species oven 205B is configured to have an atomic object comprising matter comprising atomic objects of the second species disposed therein. Heating the atomic object comprising matter causes atomic objects of the corresponding species to be converted from a solid state of matter to a gaseous state of matter within the heating chamber 202. The atomic objects in the gaseous state exit the corresponding oven 205 via the oven nozzle 208 (e.g., 208A, 208B). In various embodiments, the oven nozzles 208A, 208B are configured to direct the atomic objects in the gaseous state into the MOT chamber 216. For example, the atomic objects exit the ovens 205A, 205B via the respective oven nozzle 208A, 208B and enter the MOT chamber 216 where they experience the electro-magnetic field of the 2D MOT. For example, the ovens 205 are each configured to generate a respective atomic flux of a respective atomic species via the respective oven nozzle 208. In various embodiments, each oven nozzle 208A, 208B is a microcapillary array. For example, an oven nozzle 208 comprises a plurality of microcapillaries or microtubes.

As noted above, the 2D MOT is configured to affect the velocity of the atomic objects such that the respective velocities of the atomic objects become aligned with the MOT axis 256. In particular, a cloud of atomic objects (e.g., comprising atomic objects of both the first species and second species) enters the MOT chamber 216. The electro-magnetic field of the 2D MOT (generated by the magnet array 212 and the optical field formed by reflecting the optical beams from the mirror array 214) transforms the cloud of atomic objects into a substantially collimated atomic object beam. For example, the 2D MOT is configured to generate a substantially collimated atomic beam from the respective atomic fluxes generated by the one or more ovens 205. In various embodiments, the substantially collimated atomic object beam 5 has a beam diameter that is less than ten millimeters (e.g., approximately 5 millimeters or less).

In various embodiments, the substantially collimated atomic object beam is dispensed from the loading assembly 200 via differential pumping tube 230. In various embodiments, the substantially collimated atomic object beam exiting the through the path of the support structure 218 continues to flow along the beam path axis 250 along the beam path 235 defined by the differential pumping tube 230. In an example embodiment, the differential pumping tube 230 may further be used to further collimate the substantially collimated atomic object beam, adjust the velocity of the atomic objects of the substantially collimated atomic object beam (e.g., adjust the velocity component in the direction along the beam path axis 250), and/or the like. For example, atomic objects having velocities that are not aligned with the beam path axis 250 will tend to collide with the wall of the differential pumping tube 230 and not be dispensed as part of the substantially collimated atomic object beam 5. For example, the differential pumping tube 230 reduces and/or prevents background gas generated by the heating and/or operation of the ovens 205 from entering the cryostat and/or vacuum chamber 40.

The substantially collimated atomic object beam 5 exits the loading assembly 200 via the differential pumping tube 230 and continues to travel in a direction aligned with the beam path axis 250. In various embodiments, the differential pumping tube 230 is positioned and/or configured such that the substantially collimated atomic object beam 5 exiting the differential pumping tube 230 is directed toward the loading position 305 of the atomic object confinement apparatus 300. For example, the beam path axis 250 may be aligned with the loading position 305 of the atomic object confinement apparatus 300.

The housing 215 of the loading assembly 200 also includes a number of diagnostic viewports 225 (e.g., 225A-E) and a gate valve 220 to allow separate testing of the MOT assembly 201 as a module and maintenance of either the cryostat and/or vacuum chamber 40 and/or contents thereof or the MOT assembly 201 without breaking vacuum on the other part of the complete assembly. In various embodiments, the MOT assembly comprises the optical couplers 210, mirror array 214, magnet array 212, a frame or support structure 218 to which the mirror array and/or magnet array is mounted, MOT chamber 216, dispensing chamber 236, the differential pumping tube 230, and/or ovens 205.

In various embodiments, the loading assembly 200 is configured to selectively provide a substantially collimated atomic object beam 5. In various embodiments the 2D MOT enables the loading assembly 200 to selectively provide the substantially collimated atomic object beam 5. For example, in various embodiments, when the one or more deflection manipulation signals and repump manipulation signals (e.g., optical beams) are present to form the 2D MOT (e.g., one or more manipulation sources 60 are generating and providing the respective manipulation signals/optical beams), the loading assembly 200 provides the substantially collimated atomic object beam 5. However, when the optical beams are not present to form the 2D MOT (e.g., the one or more manipulation sources 60 are not generating and providing and/or a modulator prevents the manipulation signals/optical beams from being coupled into the loading assembly 200 via the optical coupler 210), the atomic objects within the MOT chamber 216 are not captured and/or deflected so as to form the substantially collimated atomic object beam 5. Rather, the atomic objects within the MOT chamber 216 will be pumped out via the ion pump and/or other vacuum pump (e.g., coupled to the MOT chamber 216 via connector 262, for example). In various embodiments, the effective switching time is in a range of two to ten milliseconds (e.g., approximately 5 milliseconds). As used herein, the effective switching time is the length of time between when a command to stop or start providing the substantially collimated atomic object beam 5 is executed by a processing device (e.g., of the controller 30) and/or provided to a driver of the manipulation source 60 and when the substantially collimated atomic object beam 5 stops or starts being dispensed by the loading assembly 200 and/or being incident on the loading position 305 of the atomic object confinement apparatus 300. This allows for a faster response to various events, such as needing to re-populate the atomic object population within the atomic object confinement apparatus due to atomic object loss caused by collisions with background gas, for example.

### Example Method for Selecting Laser Tones for 2D MOT

In various scenarios, an atomic object species and/or isotope is to be provided to a confinement apparatus 300 and/or loading position 305 of a confinement apparatus 300 that has a non-zero nuclear spin. For species/isotopes of atomic objects having non-zero nuclear spins, there are a significant number of decay states into which the atomic object may decay as a result of and/or as part of an individual deflection event of the atomic object. For example, in the example of ¹³⁷Ba, which has a nuclear spin of 3/2, there are eleven states other than the ¹S₀ first state that the atomic object may decay to as a result of and/or as part of an individual deflection event using a ¹S₀ to ¹P₁ transition.

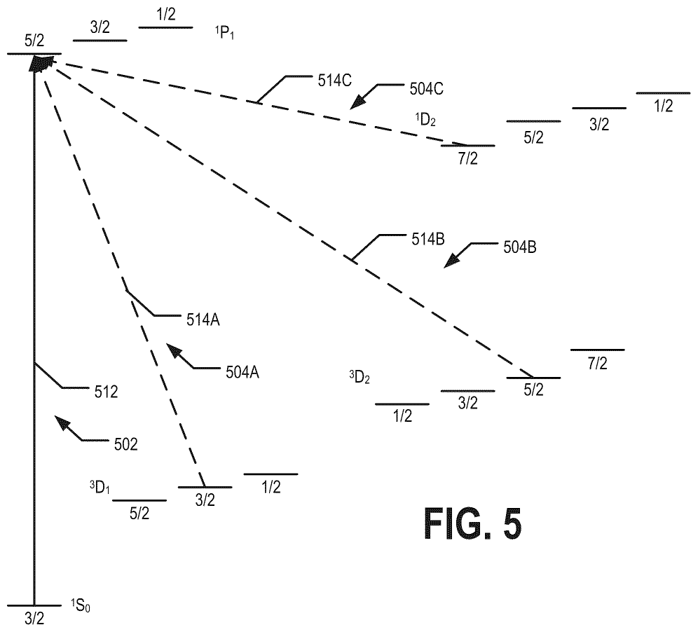

For example, FIG. 5 provides a partial energy diagram of ¹³⁷Ba, including the ¹S₀[3/2], ³D₁[5/2], ³D₁[3/2], ³D₁[1/2], ³D₂[1/2], ³D₂[3/2], ³D₂[5/2], ³D₂[7/2], ¹D₂[7/2], ¹D₂[5/2], ¹D₂[3/2], ¹D₂[1/2], ¹P₁[5/2], ¹P₁[3/2], and ¹P₁[1/2] states. The deflection manipulation signal 512 is characterized by a frequency that corresponds to the energy difference between a first state of the atomic object (e.g., the ¹S₀[3/2] state used in this example embodiment as the first state of the deflection transition) and a second state of the atomic object (e.g., the ¹P₁[5/2] state used in this example embodiment as the second state of the deflection transition). For example, in various embodiments, the deflection manipulation signal 512 is red detuned from resonance with a deflection transition 502.

Once the atomic object undergoes the deflection transition 502 and is in the second state (e.g., the ¹P₁[5/2] state), the atomic object may decay to one of a plurality of decay states (e.g., the first state (¹S₀[3/2]), ³D₁[5/2], ³D₁[3/2], ³D₁[1/2], ³D₂[1/2], ³D₂[3/2], ³D₂[5/2], ³D₂[7/2], ¹D₂[7/2], ¹D₂[5/2], ¹D₂[3/2], or ¹D₂[1/2]). In various embodiments, hundreds or thousands of individual deflection events are used to align the velocity of a respective atomic object with the MOT axis. However, an individual deflection event can only be performed on the atomic object when the atomic object is in the first state (e.g., the initial ¹S₀[2/3] state). Therefore, using conventional practices, the 2D MOT should include a repump manipulation signal corresponding to each of the plurality of decay states into which the atomic object may decay as a result of and/or as part of an individual deflection event that are not the first state (e.g., a repump manipulation signal for each of the ³D₁[5/2], ³D₁[3/2], ³D₁[1/2], ³D₂[1/2], ³D₂[3/2], ³D₂[5/2], ³D₂[7/2], ¹D₂[7/2], ¹D₂[5/2], ¹D₂[3/2], or ¹D₂[1/2]) states). Repumping of the atomic object provides a path for the atomic object to transition back to the appropriate first state (e.g., the initial ¹S₀ state) such that another individual deflection event can be performed on the atomic object.

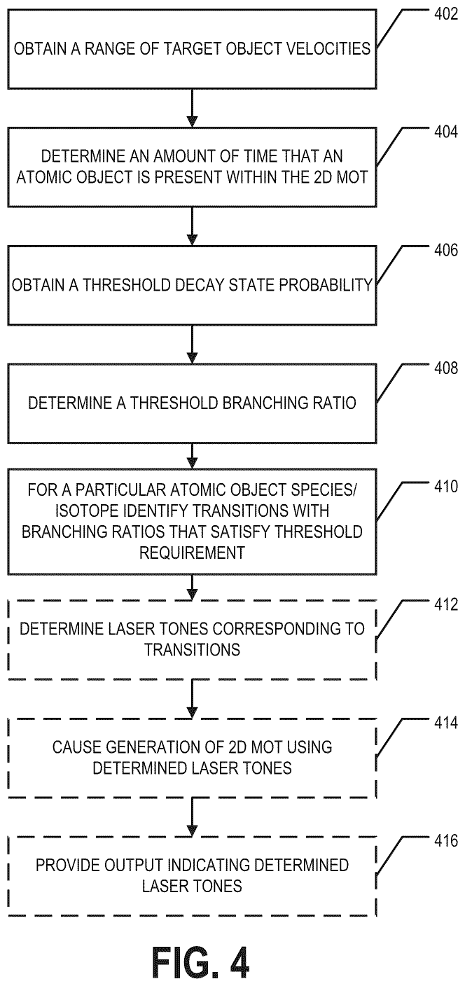

FIG. 4 provides a flowchart illustrating various processes, procedures, and/or the like for reducing the number of repump manipulation signals required to effectively repump the atomic objects such that the 2D MOT forms a collimated atomic beam from one or more atomic fluxes. In various embodiments, one or more of the steps shown in the flowchart of FIG. 4 are performed by a (classical and/or semiconductor-based) computing entity 10. In various embodiments, the computing entity 10 that performs one or more of the steps shown in the flowchart of FIG. 4 is a computing entity 10A that is part of the quantum computing system 100 or another computing entity 10 (e.g., a computing entity that is not in communication with the controller 30).

Starting at step 402, a range of target object velocities is obtained. The range of target object velocities corresponds to a range of atomic object velocity components that are aligned with and/or parallel to the MOT axis 256. For example, in various embodiments, the range of target object velocities is determined based on the abilities of the confinement apparatus 300 to trap atomic objects from the collimated beam of atomic objects. For example, the atomic beam is provided to a loading position 305 of the confinement apparatus 300. The confinement apparatus 300 is only able to (ionize,) trap and confine atomic objects having velocities equal to or lower than a threshold confinement velocity. Therefore, at least an upper limit of the range of target object velocities is determined based on the strength of the confinement provided by the confinement apparatus 300. In an example embodiment the upper limit of the range of target object velocities is 90 m/s.

In an example embodiment, the atomic object must have a velocity that is non-zero in order for the atomic object to exit the 2D MOT and be directed to the confinement apparatus 300. In an example embodiment, a lower limit of the range of target object velocities is set so that the confinement apparatus 300 may be efficiently loaded with atomic objects. For example, in various embodiments, the lower limit of the range of target object velocities is 20 m/s, 30 m/s, 40 m/s, or 50 m/s.

In an example embodiment, the lower limit of the range of target object velocities is set by the threshold branching ratio. For example, an atomic object moving through the 2D MOT more slowly will experience more scattering and/or deflection events then an atomic object moving through the 2D MOT more quickly. The more scattering and/or deflection events an atomic object experiences, the higher the probability that the atomic object will fall into a dark state (e.g., a decay state not addressed by one of the repumping beams). In an example embodiment, setting the threshold branching ratio to 1:10,000 limits the lower limit of the range of target object velocities to 50 m/s. For example, atomic object with an axial velocity through the 2D mot of less than the lower limit of the range of target object velocities are likely to experience a high enough number of scattering and/or deflection events that the atomic object will decay into a dark state (e.g., a decay state not addressed by one of the repumping beams) before exiting the 2D MOT. Even atomic objects that have been sufficiently cooled and deflected, if they are in a dark state generally cannot be ionized for loading the ion into the ion trap.

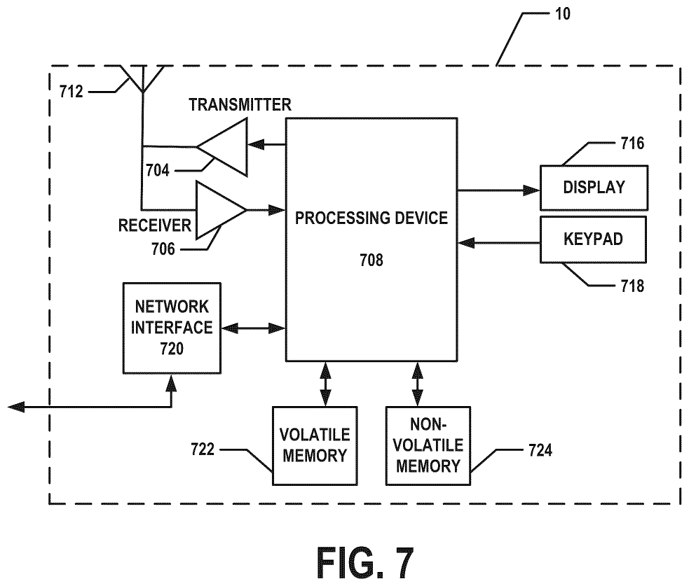

In various embodiments, a computing entity 10 obtains the range of target object velocities. In an example embodiment, the computing entity 10 obtain the range of target object velocities by a processing device 708 accessing the range of target object velocities from a memory 722, 724 (see FIG. 7) that is accessible to the processing device 708.

In another example, the computing entity 10 obtains the range of target object velocities via a user interface and user interaction therewith. For example, the computing entity 10 may display a user interface via display 716 and receive user input via a user input device (e.g., via keypad 718, a touchscreen, mouse, and/or the like) indicating the range of target object velocities.

In another example, the computing entity 10 receives the range of target object velocities as a digital communication. For example, another computing entity may provide (e.g., transmit) an indication of the range of target object velocities such that the computing entity 10 receives the indication of the range of target object velocities via receiver 706 and/or network interface 720.

In still another example, the computing entity 10 may receive or access sensor data or simulation data that the computing entity 10 processes to determine a threshold confinement velocity of the confinement apparatus 300 and/or a minimum atomic object velocity that enables the efficient loading of the confinement apparatus 300 with atomic objects. The computing entity 10 may then determine the range of target object velocities by setting the upper limit of the range of target object velocities equal to the threshold confinement velocity and setting the lower limit of the range of target object velocities to the minimum atomic object velocity that enables the efficient loading of the confinement apparatus.

For example, the computing entity comprises means, such as processing device 708, memory 722, 724, receiver 706, transmitter 704, network interface 720, user input/output devices such as display 716 and/or keypad 718, and/or the like, for obtaining a range of target object velocities.

At step 404, an amount of time (or range of times) that an atomic object is present within the 2D MOT is determined. For example, the length L of the MOT chamber 216 in a direction parallel to the MOT axis 256 is known. The amount of time a particular atomic object is present within the 2D MOT is dependent on the particular atomic object's velocity component v along the MOT axis. Therefore, the amount of the time the particular atomic object is present within the 2D MOT is given by L/v. Based on the upper limit and/or lower limit of the range of target object velocities and the length L of the MOT chamber 216, the amount of time (or range of times) an atomic object is present within the 2D MOT is determined. In an example embodiment, the amount of time that an atomic object is present within the 2D MOT is approximately half a millisecond. In an example embodiment, the computing entity 10 determines the amount of time (or range of times) that an atomic object is present within the 2D MOT. For example, the computing entity 10 comprises means, such as processing device 708, memory 722, 724, and/or the like for determining the amount of time (or range of times) that an atomic object is present within the 2D MOT.

At step 406, a threshold decay state probability is obtained. In various embodiments, an atomic object that is in the second state will decay into a respective decay state with a respective decay state probability. For example, the probability that an example ¹³⁷Ba atom will decay from the second state (e.g., the ¹P₁[5/2] state) to the ³D₁[5/2] state is different from the probability that the example 137Ba atom will decay from the second state (e.g., the ¹P₁[5/2] state) to the ³D₁[3/2] state. The threshold decay state probability defines a minimum probability that an atomic object will decay from the second state into a respective decay state for respective decay states that will be addressed by repump manipulation signals. In other words, the threshold decay state probability defines a maximum decay state probability for a decay state that will not be addressed by a repump manipulation signal. In various embodiments, the threshold decay state probability is set and/or defined based on requirements of the application, system hardware, and/or the like. In various embodiments, the threshold decay state probability is a cumulative measurement. In other words, the threshold decay state probability is the probability that an atomic object will have fallen into the decay state by the completion of the MOT process (e.g., when the atomic object exits the 2D MOT).

In various embodiments, the computing entity 10 obtains the threshold decay state probability. For example, the computing entity 10 may access the threshold decay state probability from memory, receives user input providing an indication of the threshold decay state probability via a user input/output device, receives the threshold decay state via an electronic communication with another computing entity, and/or the like. For example, the computing entity 10 comprises means, such as processing device 708, memory 722, 724, receiver 706, transmitter 704, network interface 720, user input/output devices such as display 716 and/or keypad 718, and/or the like, for obtaining a threshold decay state probability.

At step 408, based at least in part on the threshold decay state probability and the amount of time (or range of times) that an atomic object will be present in the 2D MOT, a threshold branching ratio is determined. A branching ratio is the probability that an atomic object will decay from a specific excited state to a specific decay state given a spontaneous scattering event. For example, returning to the example ¹³⁷Ba atom, the branching ratio for a particular decay state provides the probability that the ¹³⁷Ba atom will decay from the second state (e.g., the ¹P₁[5/2] state) to a particular decay state.

In an example embodiment, the threshold branching ratio is determined by determining a number of decay events (e.g., from the second state after a deflection event) that an atomic object is expected to undergo while the atomic object is present in the 2D MOT. For example, if a particular rate of deflection events is expected while the atomic object is present in the 2D MOT, the particular rate of deflection events multiplied by the amount of time the atomic object is present in the 2D MOT provides an estimate for the number of deflection events the atomic object is expected to undergo. Based on the threshold decay state probability and the number of deflection events the atomic object is expected to undergo while present in the 2D MOT, the threshold branching ratio is determined. For example, the threshold branching ratio is the branching ratio of a (theoretical) state that would have a decay state probability equal to the threshold decay state probability.

In an example embodiment, the computing entity 10 determines the threshold branching ratio. For example, in various embodiments, the computing entity 10 comprises means, such as processing device 708, memory 722, 724, and/or the like, for determining the threshold branching ratio. In an example embodiment, the threshold branching ratio is 1:10,000.

At step 410, for a particular atomic object species/isotope, decay states of the particular atomic object species/isotope that have branching ratios with respect to the second state that satisfy a threshold requirement are identified. In various embodiments, a decay state satisfies the threshold requirement when the branching ratio corresponding to the decay state with respect to the second state is greater than or equal to the threshold branching ratio. For example, decay states of the particular atomic object species/isotope that are identified as having branching ratios with respect to the second state that satisfy the threshold requirement are the decay states to be addressed by repumping manipulation signals of the 2D MOT. For example, the decay states of the particular atomic object species/isotope that are identified as having branching ratios with respect to the second state that satisfy the threshold requirement are the decay states that respective repump manipulation signals are configured to address. For example, a respective repump manipulation signal is configured to address a decay state to cause repumping of the atomic object from the decay state via a suitable excited state so that the atomic object has the opportunity to decay back to the first state. An excited state of the atomic object is a suitable excited state if there is a sufficiently high probability (e.g., greater than zero, greater than 10%, greater than 20%, greater than 30%, greater than 40%, greater than 50%, or higher in various embodiments) that the atomic object will decay from the excited state to the first state in a given time frame.

In various embodiments, identifying decay states of the particular atomic object species/isotope that have branching ratios with respect to the second state that satisfy a threshold requirement comprises comparing respective branching ratios of respective decay states with respect to the second state to the threshold branching ratio to determine which of the respective decay states satisfy the threshold requirement.

In various embodiments, the branching ratio of a particular second state to decay state transition may be determined based on empirical data (gathered directly or from the literature). For example, empirically determined transition matrix elements or scattering rates of the atomic object may be obtained. Quantum theory may then be used to determine respective branching ratios based on the empirically determined transition matrix elements or scattering rates of the atomic object.

In various embodiments, the computing entity 10 identifies to decay states of the particular atomic object species/isotope that have branching ratios with respect to the second state that satisfy a threshold requirement. For example, in various embodiments, the computing entity 10 comprises means, such as processing device 708, memory 722, 724, and/or the like, for identifying decay states of the particular atomic object species/isotope that have branching ratios with respect to the second state that satisfy a threshold requirement.

At step 412, laser tones corresponding to each of the identified decay states having branching ratios with respect to the second state that satisfy the threshold requirement are determined. For example, for a respective identified second state to decay state transition that was identified as having a branching ratio that satisfies the threshold requirement, a frequency and/or energy difference between the second state and the decay state of the respective second state to decay state transition is determined. For example, as shown in FIG. 5, the second state to decay state transition 504A between the second state (e.g., ¹P₁[5/2]) and the decay state ³D₁[3/2] is identified as a second state to decay state transition that has a branching ratio that satisfies the threshold requirement, in an example embodiment. The frequency and/or energy difference between a suitable excited state (e.g., the second state (e.g., ¹P₁[5/2]) or another excited state of the atomic object) and the decay state ³D₁[3/2] is determined such that a frequency or wavelength for repump manipulation signal 514A can be determined based thereon. In an example embodiment, the repump manipulation signal 514A is on resonance with the suitable excited state to decay state transition 504A.

In the illustrated example of FIG. 5, the second state to decay state transition 504B corresponding to decay state ³D₂[5/2] and second state to decay state transition 504C corresponding to decay state ¹D₂[7/2] are identified as having respective branching ratios that satisfy the threshold requirement. Laser tones corresponding to second state to decay state transitions 504B, 504C are determined based on the energy structure of the particular atomic object species/isotope to determine respective frequency/wavelengths of the repump manipulation signals 514B, 514C. In various embodiments, the frequency and/or energy difference between the suitable excited state and a respective decay state may be determined theoretically, empirically, and/or via simulation.

In an example embodiment, of the eleven second state to decay state transitions where the decay state is not the first state in energy structure of the example ¹³⁷Ba atom, only the second state to decay state transitions 504A, 504B, 504C were identified as having branching ratios that satisfy the threshold requirement. Therefore, instead of the 2D MOT including eleven repump manipulation signals, the 2D MOT may only include three repump manipulation signals 514A, 514B, 514C configured to address the ¹³⁷Ba atoms of the atomic flux.

In an example embodiment, one or more of the repump manipulations signals 514A, 514B, 514C addresses more than one decay state. For example, the frequency and/or energy difference between a first suitable excited state and a first decay state having a branching ratio with respect to the second state that satisfies the threshold requirement may be sufficiently similar to the frequency and/or energy difference between a second decay state (independent of the branching ratio thereof) and a second suitable excited state. Therefore, the same repump manipulation signal may be able to repump the first decay state via the first suitable excited state and the second decay sate via the second suitable excited state, where the first decay state and the second decay states are different states. The first suitable excited state and the second suitable excited state may be the same state or two different states.

In an example embodiment, the computing entity 10 determines laser tones corresponding to each of the identified decay states where a laser tone corresponding to a decay state is characterized by a wavelength/frequency that corresponds to a transition between the respective decay state and a suitable excited state. For example, in various embodiments, the computing entity 10 comprises means, such as processing device 708, memory 722, 724, and/or the like, for determining suitable excited state to decay state transitions of the particular atomic object species/isotope for decay states that have branching ratios with respect to the second state that satisfy a threshold requirement.

At step 414, a 2D MOT is generated within the MOT chamber 216 that includes the determined laser tones. For example, the computing entity 10 may control operation of one or more manipulation sources 60 and/or may provide information to a controller 30 of a system including the loading assembly 200 such that the controller 30 controls operation of one or more manipulation sources 60 to cause the manipulation sources to generate and provide repump manipulation signals 514A, 514B, 514C, characterized by respective determined laser tones, to the loading assembly 200 (e.g., via optical coupler 210) such that a 2D MOT including the repump manipulation signals 514A, 514B, 514C is formed and/or provided in the MOT chamber 216. In various embodiments, the computing entity 10 comprises means, such as processing device 708, memory 722, 724, network interface 720, and/or the like, to cause a 2D MOT to be generated within the MOT chamber 216 that includes the determined laser tones as repump manipulation signals.

At step 416, the computing entity 10 provides output indicating the determined laser tones. For example, the computing entity 10 may display the determined laser tones via display 716. In another example, the computing entity 10 may provide an electronic message (e.g., to controller 30 and/or to another computing entity) indicating and/or providing the determined laser tones. For example, the computing entity 10 comprises means, such as processing device 708, memory 722, 724, display 716, transmitter 704, network interface 720, and/or the like for providing output indicating the determined laser tones.

### Technical Advantages

For species/isotopes of atomic objects having non-zero nuclear spin, there are a significant number of decay states into which the atomic object may decay from the second state after a deflection event. For example, in the example of ¹³⁷Ba, there are eleven states other than the first state that the atomic object may decay to from the second state. Therefore, according to conventional practice, a 2D MOT for forming an atomic beam of ¹³⁷Ba from an oven provided atomic flux of ¹³⁷Ba would include a deflection manipulation signal characterized by a frequency corresponding to the deflection transition (e.g., the transition from the first state to the second state of the atomic object) and eleven repump manipulation signals, each characterized by a respective frequency corresponding to a transition from a respective decay state to a suitable excited state. In other words, a 2D MOT for forming an atomic beam of ¹³⁷Ba from an oven provided atomic flux of ¹³⁷Ba would require twelve different laser tones, according to conventional practice.

As should be understood, generating a 2D MOT including twelve different laser tones is technically complex. Therefore, there are technical problems for generating a 2D MOT configured to collimate atomic objects having non-zero nuclear spin.

Embodiments of the present disclosure provide technical solutions to these technical problems. In particular, various embodiments provide a method and/or corresponding apparatus for reducing the number of possible repump manipulation signals used in a 2D MOT configured for collimating atomic objects having non-zero nuclear spin. In various embodiments, a system configured for generating a 2D MOT with a reduced number of repump manipulation signals is provided.

In various embodiments, the 2D MOT is part of a loading assembly configured to provide an atomic beam to a confinement apparatus. For an example confinement apparatus, the confinement apparatus is only capable of ionizing and trapping/confining atomic objects having velocities (and/or velocity components that are parallel to the MOT axis) that are less than or equal to a maximum velocity. This maximum velocity is the maximum target velocity for the atomic objects deflected by the 2D MOT for form the atomic beam. The deflection angle and deflection intersection of the 2D MOT is determined such that the atomic objects are sufficiently deflected and only live in the deflection intersection for a short enough time to allow for neglecting dark states with lower branching ratios (e.g., lower than a threshold branching ratio). The threshold branching ratio is determined based at least in part on the amount of time the atomic object spends in the deflection intersection of the 2D MOT. This time is determined by the target velocity and the size of the deflection intersection (e.g., the length of the 2D MOT). The deflection angle is determined by the required number of scatters to deflect the atomic objects at or below the target velocity given the size of the deflection intersection to form the atomic beam from the oven provided atomic flux.

For example, the decay states which are particularly relevant given the application and the geometry of the 2D MOT are identified. For example, the application may define a range of target object velocities. For example, the 2D MOT may be configured to provide a collimated atomic beam including atomic objects having respective axial velocities within the range of target object velocities. The geometry of the 2D MOT and the range of target object velocities provides an indication of the amount of time an atomic object will spend in the 2D MOT is determined. Based on the application, a threshold decay state probability may be set or selected. A decay state probability is the likelihood that an atomic object will decay from the second state into a respective decay state (over the period of time the atomic object is within the 2D MOT). Based on the amount of time the atomic object will spend in the 2D MOT and the threshold decay state probability, a threshold branching ratio is determined.

Decay states having a branching ratio with respect to the second state that is greater than the threshold branching ratio are identified. Laser tones and/or frequencies corresponding to respective transitions between one or more suitable excited states and the decay states having respective branching ratios with respect to the second state that are greater than the threshold branching ratio are determined, in various embodiments.

In an example embodiment, a 2D MOT is generated and/or caused to be generated that includes repump manipulation signals that are characterized by frequencies corresponding to the respective transitions between the suitable excited state(s) and decay states having respective branching ratios with respect to the second state that are greater than the threshold branching ratio. The 2D MOT does not include repump manipulation signals configured to address the decay states having respective branching ratios with respect to the second state that are less than the threshold branching ratio (unless the repump manipulation signal also addresses a decay state having a branching ratio with respect to the second state that is greater than the threshold branching ratio). In the illustrated example, the conventional eleven repump manipulation signals are reduced to three repump manipulation signals without any substantial negative effect on the ability of the 2D MOT to generate a collimated atomic beam from the atomic flux.

Thus, various embodiments provide for 2D MOTs that are configured to collimate atomic objects having non-zero integer nuclear spin but with a significantly reduced technical implementation complexity. For example, in various embodiments, the number of repump manipulation signals of the 2D MOT configured to address an atomic object having non-zero nuclear spin is similar to the number of repump manipulation signals of a 2D MOT configured to address an atomic object having zero nuclear spin. For example, in an example embodiment, a 2D MOT configured to collimate ¹³⁷Ba into an atomic beam includes three repump manipulation signals (e.g., three laser tones configured for repumping the ¹³⁷Ba) compared to the eleven repump manipulation signals required by conventional practice. Therefore, embodiments provide improvements to the technical fields of 2D MOTs and loading atomic objects into an atomic object confinement apparatus.

### Exemplary Controller

In various embodiments, an atomic object confinement apparatus 300 is incorporated into a system (e.g., a quantum computer 110) comprising a controller 30. In various embodiments, the controller 30 is configured to control various elements of the system (e.g., quantum computer 110). For example, the controller 30 may be configured to control the voltage sources, a cryostat system and/or vacuum system controlling the temperature and pumping within the cryostat and/or vacuum chamber 40, manipulation sources 60, cooling system, and/or other systems controlling the environmental conditions (e.g., temperature, humidity, pumping, and/or the like) within the cryostat and/or vacuum chamber 40 and/or configured to manipulate and/or cause a controlled evolution of quantum states of one or more atomic objects confined by the atomic object confinement apparatus 300. In various embodiments, the controller 30 may be configured to receive signals from one or more optics collection systems.

As shown in FIG. 6, in various embodiments, the controller 30 may comprise various controller elements including processing device 605, memory 610, driver controller elements 615, a communication interface 620, analog-digital converter elements 625, and/or the like. For example, the processing device 605 may comprise processing elements, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing device 605 of the controller 30 comprises a clock and/or is in communication with a clock.

For example, the memory 610 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 610 may store a queue of commands to be executed to cause a quantum algorithm and/or circuit to be executed (e.g., an executable queue), qubit records corresponding the qubits of quantum computer (e.g., in a qubit record data store, qubit record database, qubit record table, and/or the like), a calibration table, computer program code (e.g., in a one or more computer languages, specialized controller language(s), and/or the like), and/or the like. In an example embodiment, execution of at least a portion of the computer program code stored in the memory 610 (e.g., by a processing device 605) causes the controller 30 to perform one or more steps, operations, processes, procedures and/or the like described herein for providing manipulation signals to form the 2D MOT and/or ionize atomic objects in the confining potential of the atomic object confinement apparatus, operate the ovens, and/or the like such that atomic objects are loaded into the atomic object confinement apparatus 300.

In various embodiments, the driver controller elements 615 may include one or more drivers and/or controller elements each configured to control one or more drivers. In various embodiments, the driver controller elements 615 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 605). In various embodiments, the driver controller elements 615 may enable the controller 30 to operate a voltage sources (e.g., for controlling the confining potential of the atomic object confinement apparatus, operating the ovens, and/or the like), manipulation sources 60, cooling system, and/or the like. In various embodiments, the drivers may be laser drivers configured to operate one or manipulation sources 60 to generate manipulation signals; vacuum component drivers; drivers for controlling the flow of current and/or voltage applied to electrodes used for maintaining and/or controlling the trapping and/or confining potential of the atomic object confinement apparatus 300 (and/or other drivers for providing driver action sequences to potential generating elements of the atomic object confinement apparatus); cryostat and/or vacuum system component drivers; cooling system drivers, and/or the like. In various embodiments, the controller 30 comprises means for communicating and/or receiving signals from one or more optical receiver components (e.g., photodetectors 50 of the optics collection system). For example, the controller 30 may comprise one or more analog-digital converter elements 625 configured to receive signals from one or more optical receiver components (e.g., a photodetector 50 of the optics collection system), calibration sensors, and/or the like.

In various embodiments, the controller 30 may comprise a communication interface 620 for interfacing and/or communicating with a computing entity 10. For example, the controller 30 may comprise a communication interface 620 for receiving executable instructions, command sets, and/or the like from the computing entity 10 and providing output received from the quantum computer 110 (e.g., from an optical collection system) and/or the result of a processing the output to the computing entity 10. In various embodiments, the computing entity 10 and the controller 30 may communicate via a direct wired and/or wireless connection and/or via one or more wired and/or wireless networks 20.

### Exemplary Computing Entity

FIG. 7 provides an illustrative schematic representative of an example computing entity 10 that can be used in conjunction with embodiments of the present invention. In various embodiments, the computing entity 10 is a classical and/or semiconductor-based computer (e.g., a desktop computer, laptop computer, tablet, and/or the like). In various embodiments, the computing entity 10 is configured to perform one or more actions and/or steps illustrated in the flowchart provided by FIG. 4. For example, the computing entity 10 may include memory 722, 724 that stores executable instructions configured to, when executed by a processing device 708 of the computing entity 10, cause the computing entity 10 to perform one or more actions and/or steps illustrated in the flowchart provided by FIG. 4. In various embodiments, a computing entity 10A is configured to allow a user to provide input to the quantum computer 110 (e.g., via a user interface of the computing entity 10) and receive, display, analyze, and/or the like output from the quantum computer 110.

In various embodiments, the computing entity 10 includes a processing device 708. For example, the processing device 708 may comprise processing elements, programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing device 708 of the computing entity 10 comprises a clock and/or is in communication with a clock.

As shown in FIG. 7, a computing entity 10 can include an antenna 712, a transmitter 704 (e.g., radio), a receiver 706 (e.g., radio). The processing device 708 provides signals to and receives signals from the transmitter 704 and receiver 706, respectively. The signals provided to and received from the transmitter 704 and the receiver 706, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

The computing entity 10 may also comprise a user interface device comprising one or more user input/output devices and/or interfaces (e.g., a display 716 and/or speaker/speaker driver coupled to a processing device 708 and a touch screen, keyboard, mouse, and/or microphone coupled to a processing device 708). For instance, the user output device and/or interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input device and/or interface can comprise any of a number of devices allowing the computing entity 10 to receive data, such as a keypad 718 (hard or soft), a touch display, voice/speech or motion interfaces, scanners, readers, or other input device. In embodiments including a keypad 518, the keypad 718 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 722 and/or non-volatile storage or memory 724, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for selecting repump laser tones for use in a two-dimensional (2D) magneto-optical trap (MOT), wherein the 2D MOT is configured to deflect atomic objects of a first atomic object species/isotope via photon scattering using a deflection manipulation signal corresponding to a transition between a first state and a second state of the first atomic object species/isotope, the method comprising:
obtaining a range of target object velocities;
based at least in part on the range of target object velocities, determining an amount of time that an object is present within the 2D MOT;
obtaining a threshold decay state probability;
based at least in part on the amount of time that an object is present within the 2D MOT and the threshold decay state probability, determining a threshold branching ratio; and
identifying one or more decay states of the first atomic object species/isotope that are characterized by respective branching ratios that are greater than or equal to the threshold branching ratio, wherein there is a non-zero probability that an atomic object of the first atomic object species/isotope will decay from the second state to each respective decay state of the one or more decay states.

2. The method of claim 1, further comprising determining laser tones corresponding to respective transitions between the one or more decay states and a respective suitable excited state.

3. The method of claim 2, further comprising causing generation of a 2D MOT comprising the laser tones, wherein the 2D MOT is configured to cause an atomic beam generated from one or more atomic fluxes provided by one or more oven nozzles to be provided to a loading region of a confinement apparatus.

4. The method of claim 3, wherein the range of target object velocities is determined based on a threshold kinetic energy of atomic objects provided to the loading region of the confinement apparatus that the confinement apparatus is capable of trapping.

5. The method of claim 3, wherein the atomic beam comprises the atomic objects of the first atomic object species/isotope and atomic objects of a second atomic object species/isotope.

6. The method of claim 1, wherein the first atomic object species/isotope has a non-zero nuclear spin.

7. The method of claim 1, wherein the range of target object velocities is velocities greater than 0 m/s and no more than 90 m/s.

8. The method of claim 1, wherein the threshold branching ratio is 1:10,000.

9. A loading assembly for providing atomic objects to a confinement apparatus, the loading assembly comprising:
one or more ovens, each oven of the one or more ovens (a) comprising a respective oven nozzle and (b) configured to generate a respective atomic flux of a respective atomic species via the respective oven nozzle;
a mirror array and a magnet array configured to, when optical beams are provided to the mirror array, generate a two-dimensional magneto-optical trap (2D MOT), wherein the 2D MOT is configured to generate a substantially collimated atomic beam from the respective atomic fluxes generated by the one or more ovens, at least in part by deflecting the atomic objects of a first atomic object species/isotope via photon scattering using a deflection manipulation signal corresponding to a transition between a first state and a second state of the first atomic object species/isotope; and
a differential pumping tube defining a beam path, wherein the differential pumping tube is configured to provide the substantially collimated atomic beam via the beam path,
wherein the optical beams of the 2D MOT comprise one or more repump manipulation signals configured to address a first respective atomic species, the one or more repump manipulation signals consist of respective laser beams characterized by respective frequencies that correspond to respective transitions between a respective suitable excited state and a respective decay state associated with a respective branching ratio with respect to the second state that is greater than or equal to a threshold branching ratio, wherein there is a non-zero probability that an atomic object of the first atomic object species/isotope will decay from the second state to the respective decay state.

10. The loading assembly of claim 9, wherein the threshold branching ratio is determined by:
obtaining a range of target object velocities;
based at least in part on the range of target object velocities, determine an amount of time that an object is present within the 2D MOT;
obtaining a threshold decay state probability; and
based at least in part on the amount of time that an object is present within the 2D MOT and the threshold decay state probability, determining the threshold branching ratio.

11. The loading assembly of claim 10, wherein the 2D MOT is configured to cause the substantially collimated atomic beam to be provided to a loading region of the confinement apparatus.

12. The loading assembly of claim 11, wherein the range of target object velocities is determined based on a threshold kinetic energy of atomic objects provided to the loading region of the confinement apparatus that the confinement apparatus is capable of trapping.

13. The loading assembly of claim 11, wherein the substantially collimated atomic beam comprises the atomic objects of the first atomic object species/isotope and atomic objects of a second atomic object species/isotope.

14. The loading assembly of claim 10, wherein the range of target object velocities is velocities greater than 0 m/s and no more than 90 m/s.

15. The loading assembly of claim 9, wherein the first respective atomic object species/isotope has a non-zero nuclear spin.

16. The loading assembly of claim 9, wherein the threshold branching ratio is 1:10,000.

17. The loading assembly of claim 9, wherein the respective oven nozzle of each of the one or more ovens is misaligned with the beam path and the 2D MOT is configured to provide the substantially collimated atomic beam in alignment with the beam path.

18. The loading assembly of claim 9, wherein the one or more repump manipulation signals comprise a first manipulation signal characterized by a first frequency that corresponds to a first transition between a first suitable excited state and the respective decay state associated with a respective branching ratio with respect to the second state that is greater than or equal to the threshold branching ratio and that corresponds to a second transition between a second suitable excited state and another second decay state, wherein there is a non-zero probability that the atomic object of the first atomic object species/isotope will decay from the second state to the other decay state.

19. An apparatus comprising a processing device and at least one memory storing computer executable instructions, the at least one memory and the computer executable instructions are configured to, when executed by the processing device, cause the apparatus to perform at least:
obtaining a range of target object velocities;
based at least in part on the range of target object velocities, determining an amount of time that an object is present within a 2D MOT;
obtaining a threshold decay state probability;
based at least in part on the amount of time that an object is present within the 2D MOT and the threshold decay state probability, determining a threshold branching ratio;
identifying one or more decay states of a first atomic object species/isotope that are characterized by respective branching ratios that are greater than or equal to the threshold branching ratio, wherein there is a non-zero probability that an atomic object of the first atomic object species/isotope will decay from the second state to each respective decay state of the one or more decay states;
determining respective laser tones each corresponding to a respective transition between a respective decay state of the one or more decay states and a respective suitable excited state; and
providing output indicating the respective laser tones.

20. The apparatus of claim 19, wherein the 2D MOT is configured to cause an atomic beam generated from one or more atomic fluxes provided by one or more oven nozzles to be provided to a loading region of a confinement apparatus, and the range of target object velocities is determined based on a threshold kinetic energy of atomic objects provided to the loading region of the confinement apparatus that the confinement apparatus is capable of trapping.
